(19) United States
(12) Patent Application Publication
(10) Pub. No.: US 2026/0222957 A1
(43) Pub. Date: Jul. 30, 2026

(54) WIRELESS COMMUNICATION SYSTEM, WIRELESS COMMUNICATION DEVICE, WIRELESS COMMUNICATION METHOD AND WIRELESS COMMUNICATION PROGRAM

(71) Applicants: NTT, Inc., Tokyo (JP); NTT DOCOMO, INC., Tokyo (JP)

(72) Inventors: Munehiro MATSUI, Musashino-shi, Tokyo (JP); Junichi ABE, Musashino-shi, Tokyo (JP); Hisayoshi KANO, Musashino-shi, Tokyo (JP); Fumihiro YAMASHITA, Musashino-shi, Tokyo (JP); Atsushi MINOKUCHI, Tokyo (JP); Fumito KUROIWA, Tokyo (JP); Kenta YAMAUCHI, Tokyo (JP); Kenji FUKASAWA, Tokyo (JP); Hinata KOHARA, Tokyo (JP); Yuto MUROKI, Tokyo (JP); Yuki HOKAZONO, Tokyo (JP)

(73) Assignees: NTT, Inc., Tokyo (JP); NTT DOCOMO, INC., Tokyo (JP)

(21) Appl. No.: 19/157,383

(22) PCT Filed: Feb. 24, 2023
(86) PCT No.: PCT/JP2023/006854

§ 371 Date: Aug. 18, 2025

(51) Int. Cl. H04W 36/26; H04W 36/14; H04W 36/22

(52) U.S. Cl. CPC H04W 36/26; H04W 36/144; H04W 36/22

(57) ABSTRACT

The present disclosure relates to a wireless communication system using a network to which an MEC technology is applied, and providing a stable service by controlling contents served from the edge server to the terminals as needed. The system includes a terminal which connects to a base station functionality provided within the network, an edge server provided within the network along with the base station functionality, and a non-edge server provided at a position away from the base station functionality within the network. The wireless communication system is configured to perform content replacement control for swapping the service handled by the edge server and the service handled by the non-edge server based on at least one of the required QoS of the services received by the terminal and the traffic volume generated by the group of terminals receiving the same service.

### TECHNICAL FIELD

The present disclosure relates to a wireless communication system, a wireless communication device, a wireless communication method, and a wireless communication program using a non-terrestrial network.

### BACKGROUND ART

In recent years, mobile communication systems have developed, and it is possible to enjoy mobile services in most parts of the world. One of the requirements of the fifth generation (5G) or sixth generation (6G) mobile communication system, which is expected to be commercially used in future, is ultra coverage. The ultra coverage means expanding the service area to locations where the installation cost of existing base stations would be expensive, or places where the setup of base stations is difficult, such as mountainous areas, maritime areas, or in the air. Additionally, there is a need for strengthening national resilience against natural disasters, and the emergence of communication systems that are resistant to ground disasters is highly desired.

To achieve the above, non-terrestrial networks (Non-Terrestrial Network: NTN) utilizing satellites, unmanned aerial vehicles (UAVs), high-altitude pseudo-satellites (HAPS), drones, and the like, are currently in the spotlight. FIG. 1 shows an example of NTN constituted by a High Altitude Platform Station (HAPS) network. An unmanned aerial vehicle flying in the stratosphere irradiates beams onto the ground, forming a mobile service area. The terminals on the ground within the mobile service area connect to the HAPS, i.e., the unmanned aerial vehicle and access the mobile network via the unmanned aircraft. The unmanned aerial vehicle is equipped with signal relay functionality, and the packets sent from the terminal are transmitted through the unmanned aerial vehicle, ground base station, and mobile network to the data network. Packets from the data network addressed to terminals are relayed in a similar way.

In the future, a multi-layer satellite network consisting of a plurality of satellites and HAPS networks can be envisioned. An example of an NTN composed of a geostationary satellite (GEO satellite), low Earth orbit satellites (LEO satellites), and HAPS networks is shown in FIG. 2. The satellites and the aerial vehicles belonging to each network connect with each other to form a network. The satellites and the aerial vehicles have routing functionality. Traffic sent from a terminal is forwarded by the satellites and/or the aerial vehicles to the internet network.

In addition, in mobile services, MEC (Multi-access Edge Computing) technology is anticipated. Edge servers are placed at locations close to the terminals, and contents and computing resources are placed on those servers. By accessing the edge server, the terminal completes communication in applications and services. According to this configuration, the response time (latency) for access can be reduced compared to conventional systems where the server is located on a data network.

Even in the non-terrestrial networks, by mounting an edge server on satellites or HAPS aircraft, it becomes possible to implement MEC. An example of MEC applied to an NTN composed of a HAPS network is shown in FIG. 3. In NTN, a large distance is formed between the terminals and the satellite/HAPS due to the altitude of satellites/HAPS, resulting in long propagation delay. Therefore, accessing the data network via satellites/HAPS might lead to significantly longer response times. Due to these circumstances, the application of MEC technology in non-terrestrial networks is highly expected.

The terminal connected to the NTN accesses the data network server via feeder links between the satellite/HAPS aircrafts and the ground base station. Then, traffic flows back and forth between the terminals and the server via the feeder link. The feeder link transmits a large amount of traffic addressed from the multitude of terminals connected to the NTN to the data network, as well as traffic addressed from the data network to the terminals. Because links with high communication capacity are required, feeder links often utilize high-frequency bands such as the Ka band, which allows for broadband communication.

However, radio waves in the high-frequency bands have the characteristic of increased power attenuation due to rain's effects. Thus, the link between the satellite/HAPS aircrafts and the ground base stations can become unstable due to extreme weather conditions, such as heavy downpours, resulting in a reduction in communication capacity and potentially leading to a disconnection of the link in the worst-case scenario.

Under such circumstances, the amount of traffic that can be transmitted and received between the NTN and the ground via feeder links decreases. In the worst-case scenario, traffic transmission becomes impossible, leading to traffic congestion within the NTN. As a result, there arises a possibility that services may not be satisfactorily available on the terminal.

As a method to address the above situation, it is known to prepare redundant feeder links, as shown in FIG. 4 (Non-patent Document 1). According to this method, if the communication capacity of the regular feeder link decreases during bad weather, switching to the redundant system can avoid traffic congestion.

### CITATION LIST

### Non Patent Literature

### Non Patent Literature 1

“SATELLITE COMMUNICATIONS AT KU, KA, AND V BANDS: PROPAGATION IMPAIRMENTS AND MITIGATION TECHNIQUES,” ATHANASIOS D. PANAGOPOULOS, PANTELIS-DANIEL M. ARAPOGLOU, AND PANAYOTIS G. COTTIS, IEEE COMMUNICATIONS The Electronic Magazine of Original Peer-Reviewed Survey Articles, 2004

### SUMMARY OF INVENTION

### Technical Problem

However, in order to prepare a redundant system, the installation of additional ground base stations, etc. is necessary, leading to increased costs for system construction.

Moreover, applying the aforementioned MEC technology to complete communication between the terminal and the edge server, in order to reduce traffic amount between the terminal and the data network, poses constraints on the edge server, which may become a problem. That is to say, the edge servers that can be mounted on satellite/HAPS vehicles are subject to strict conditions such as weight restrictions and size limitations, as well as constraints like power consumption. Therefore, the storage capacity and computational resources of the edge servers have certain limitations, and it is difficult to manage in situations where many terminals are connected or a plurality of Services exist, merely using conventional MEC technology.

The first objective of the present disclosure is to provide a wireless communication system that consistently delivers stable service by controlling contents provided from the edge server to the terminal as necessary while applying MEC technology to wireless communication using a network, to resolve the issues mentioned above.

Further, the present disclosure has a second objective to provide a wireless communication device that controls contents delivered from edge servers to terminals as necessary, in order to enable the continuous provision of stable services in systems where MEC technology is applied to wireless communication using a network.

Furthermore, the present disclosure has a third objective to provide a wireless communication method for ensuring stable continuous provision of services by controlling contents delivered from edge servers to terminals as necessary while applying MEC technology to wireless communications using a network.

Additionally, the present disclosure has a fourth objective to provide a wireless communication program for controlling contents delivered from edge servers to terminals as necessary, in order to enable the continuous provision of stable services in systems where MEC technology is applied to wireless communication using a network.

### Means to Solve Problems

The first aspect of the present disclosure is, in order to achieve the above-mentioned problems, a wireless communication system utilizing a network, comprising:
a terminal which connects to a base station functionality provided within said network;
an edge server provided within the network along with said base station functionality; and
a non-edge server provided at a position away from said base station functionality within the network, wherein
said wireless communication system is preferably configured to perform content replacement control for swapping the service handled by the edge server and the service handled by the non-edge server based on at least one of the required QOS of the services received by the terminal and the traffic volume generated by the group of terminals receiving the same service.

Further, a second aspect of the present disclosure is a wireless communication device incorporated into a wireless communication system, said wireless communication system comprising a terminal which connects to a base station functionality provided within the network, an edge server provided within the network along with said base station functionality, and a non-edge Server provided at a position away from said base station functionality within the network, wherein
said wireless communication device is preferably configured to perform content replacement control for swapping the service handled by the edge server and the service handled by the non-edge server based on at least one of the required QoS of the services received by the terminal and the traffic volume generated by the group of terminals receiving the same service.

Furthermore, a third aspect of the present disclosure is a wireless communication method utilizing a network, preferably including:
causing a terminal to connect with a base station functionality provided within the network;
causing an edge server installed within the network along with said base station functionality to handle a first service required by a terminal;
causing a non-edge server installed within the network, being away from the base station functionality, to handle a second service required by a terminal; and
swapping the service handled by said the edge server with the service handled by the non-edge server based on at least one of the required QoS of the services received by said terminal and the traffic volume generated by the group of terminals receiving the same service.

Moreover, the fourth aspect of the present disclosure is a wireless communication program executed in a wireless communication device incorporated into a wireless communication system, said wireless communication system comprising a terminal which connects to a base station functionality provided within the network, an edge server provided within the network along with said base station functionality, and a non-edge server provided at a position away from said base station functionality within the network, wherein
said wireless communication program preferably includes a computer readable program for causing said wireless communication device to perform content replacement control for swapping the service handled by the edge server and the service handled by the non-edge server based on at least one of the required QoS of the services received by the terminal and the traffic volume generated by the group of terminals receiving the same service.

### Advantageous Effects of Invention

According to the first to fourth aspects, the contents on the edge server can be switched in accordance with the status of the feeder links as well as the traffic amount that circulates between the terminal and the data server. This allows, for example, for the reduction of the traffic amount circulating within the non-terrestrial network and between the non-terrestrial network and the terrestrial network, thus avoiding traffic congestion. Additionally, for instance, in cases where transient disconnections of services occur frequently due to power attenuation due to rainfall, the influence of these disconnections can be reduced by controlling the content provided by the edge server. Furthermore, for example, it is possible to provide continuous services by controlling content based on the Satellite or UAV's orbit and course.

### BRIEF DESCRIPTION OF DRAWINGS

FIG. 1 is a diagram showing an example of an NTN configured by a HAPS network;

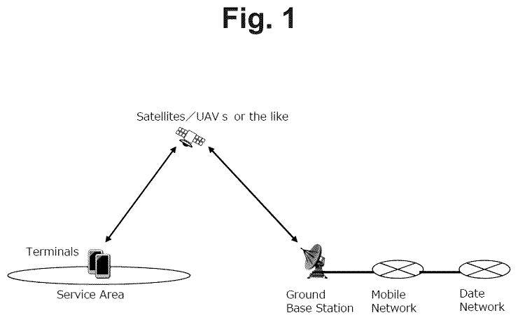

FIG. 2 is a diagram showing an example of an NTN configured by a geostationary orbit satellite (GEO satellite), low earth orbit satellites (LEO satellites), and a HAPS network;

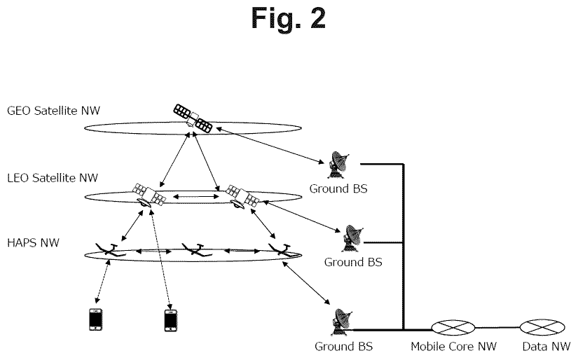

FIG. 3 is a diagram illustrating an example of applying MEC to an NTN configured by a HAPS network;

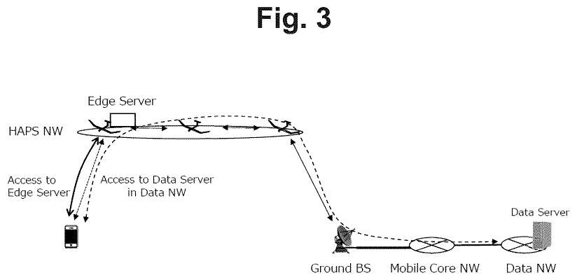

FIG. 4 is a diagram illustrating an example of an NTN prepared with redundant feeder links;

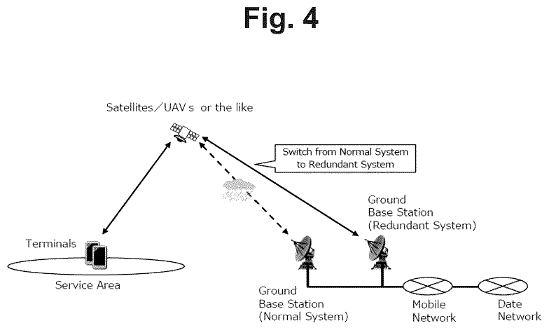

FIG. 5 is a diagram to explain the characteristics of reflections controlled by a RIS for directing reflectance;

FIG. 6 is a diagram explaining the principle by which the device in The first embodiment of the present disclosure controls reflectance power simultaneously while directing reflectance using a RIS;

FIG. 7 is a diagram explaining the hardware configuration of the control server provided in the device of the first embodiment of the present disclosure;

FIG. 8 is a flowchart to explain the process of evaluating the communication performance of a measurement object using the device of the embodiment of the present disclosure;

FIG. 9 illustrates the nature of reflections occurring in a typical indoor environment;

FIG. 10 is a diagram to explain the limits of an RIS (Reconfigurable Intelligent Surface) that controls reflective power;

FIG. 11 is a diagram showing how the device of the first embodiment of the present disclosure absorbs unnecessary reflection signals from the RIS into an absorber to eliminate them;

FIG. 12 is a diagram showing an example of an NTN consisting of a geostationary satellite (GEO satellite), low Earth orbit satellite (LEO satellite), and HAPS network;

FIG. 13 is a diagram showing an example of applying MEC to an NTN composed of a HAPS network;

FIG. 14 is a diagram showing an example of NTN with a prepared redundant feeder link; and

FIG. 15 is a diagram to explain the characteristics of reflection by RIS that controls the reflection direction.

### DESCRIPTION OF EMBODIMENTS

### First Embodiment

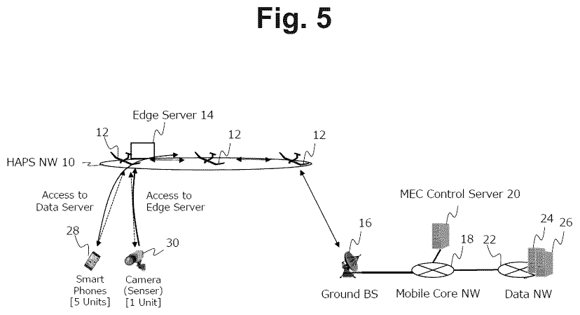

FIG. 5 shows the assumed system configuration in a first embodiment of the present disclosure. The wireless communication system under the present embodiment includes an NTN comprised of a HAPS network 10. A plurality of HAPS aircrafts 12 (unmanned aerial vehicles) are connected via wireless links. The HAPS aircraft 12 is equipped with a base station functionality and an edge server 14.

A ground base station 16 is provided on the ground. The HAPS aircraft 12 and the ground base station 16 are connected by a wireless link (feeder link). Additionally, the ground base station 16 is connected to a mobile core network 18. The mobile core network 18 is connected to an MEC control server 20. The MEC control server 20 manages the replacement of contents in the edge server 14. A data network 22 is connected to the mobile core network 18. The data network 22 has a data server 24 and a sensing server 26 connected to it.

The HAPS aircraft 12 forms a service area on the ground using the built-in base station functionality, accommodating terminals within the service area. The terminals include various devices. FIG. 5 shows an example where five smartphones 28 and one camera 30 (or sensor) are accommodated within the service area. Hereafter, when it is unnecessary to distinguish between them, both will be collectively referred to as “terminals 28, 30”.

The base station functionality provided in the HAPS aircraft 12 has the functionality to identify traffic for each service offered by the terminals 28 and 30, and based on the identified service content, it categorizes the traffic from terminals 28 and 30 as either destined for the edge server 14 or the data network 22. Furthermore, the base station functionality includes the ability to monitor the volume of traffic generated for each service and periodically transmit the observation results to the MEC control server 20.

The edge server 14 can store various contents and perform various signal processing. Additionally, the edge server 14 can replace the content and signal processing under the direction of the MEC control server 20.

The terminals 28 and 30 on the ground within the service area firstly connect to the HAPS aircraft 12. Then, they connect to the mobile core network 18 via the HAPS aircraft 12 and the ground base station 16 to receive mobile services. The terminals 28 and 30, if in a typical configuration, connect to the application servers prepared on the data network 22 beyond the mobile core network 18 to receive various application services.

The five smartphones 28 shown in FIG. 5, after connecting to the HAPS aircraft 12, access the data server 24 on the data network 22 to receive data sharing services. The data server 24 stores files, and these files are accessible for viewing from the smartphones 28.

On the other hand, the camera 30 which exists only one connects to the HAPS aircraft 12 and accesses the edge server 14. Video processing service related to the camera 30 is performed by the edge server 14 through image analysis. More specifically, the edge server 14 has functionality (software) for signal processing of video images and analyzes the images acquired by the camera 30. In other words, images sent from the camera 30 are transmitted to the edge server 14 and are processed there.

The HAPS aircraft 12 observes the amount of traffic for each service provided by terminals 28 and 30 using its base station functionality. The observation results regarding the traffic amount are periodically transmitted to the MEC control server 20. The traffic amounts at this case are, for example, as follows.
Traffic amount per smartphone: 10 Mbit/s.
Traffic amount for five smartphones: 50 Mbit/s.
Traffic amount for one camera: 100 Mbit/s.

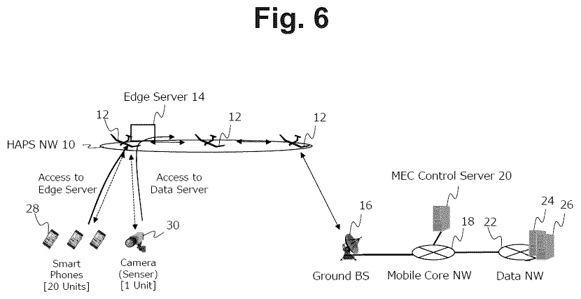

Subsequently, assuming that the number of smartphones receiving the same data sharing service increases to twenty and they connect to the HAPS aircraft 12, as shown in FIG. 6. As the smartphones 28 increased also access the data server 24 on the data network 22, the traffic amount between the group of smartphones 28 receiving the data sharing service and the data server 24 increases.

The traffic amount from twenty smartphones 28 reaches 200 Mbit/s, exceeding the traffic amount of 100 Mbit/s from camera 30. The MEC control server 20 compares the traffic amount of both services, and when the traffic amount of the data sharing service becomes larger than that of the camera 30, it changes the content stored in the edge server 14 of the HAPS aircraft 12 to one for the data sharing service purpose, and transferring the files stored in the data server 24 to the edge server 14.

After completion of transfer, the traffic destination from smartphone 28 and camera 30 is switched. Subsequently, smartphone 28 accesses the edge server 14 of the HAPS aircraft 12 to receive data sharing services. Meanwhile, images from camera 30 are sent to the sensing server 26 on the data network 22, where signal processing of the images is performed on the sensing server 26.

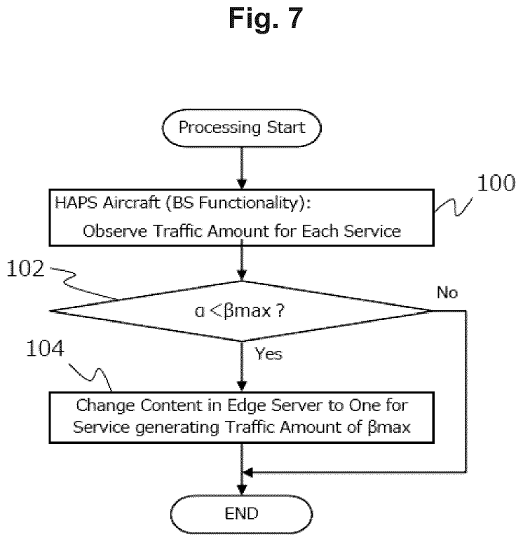

The flowchart at this situation is as shown in FIG. 7. The series of processes shown in FIG. 7 are executed on the base station functionality and the edge server 14 mounted on the HAPS aircraft 12, as well as on the MEC control server 20.

Specifically, first, the traffic amount for each service provided by the terminals in the service area is observed by the base station functionality of the HAPS aircraft 12 (step 100). The results of the observation are sent to the MEC control server 20.

The MEC control server 20 receives the results of traffic amount observation to determine if α<βmax is satisfied (Step 102). Here, first, the traffic amount α corresponding to the service that the edge server 14 handles is identified. Hereafter, the α is referred to as the “edge-handled traffic amount α”. When an edge server 14 is responsible for handling similar services provided by a plurality of terminals, the total sum of the traffic amount from these terminals is the edge-handled traffic amount α.

In this step 102, subsequently, the amount of traffic β for services handled by servers installed on the data network 22 side, rather than the edge server 14, is specified for each service. Hereinafter, the β is referred to as the “network-handled traffic amount β”. In this case, if a plurality of terminals are involved in the same type of service, then the sum of the traffic amount of those terminals is referred to as β.

Next, among all network-handled traffic amounts βs, the highest value is identified as βmax. In step 102, following the above processes, as described above, it is determined whether α<βmax is satisfied or not.

If α<βmax is not satisfied, that is, if α is greater than or equal to βmax, it can be judged that the service with the largest amount of traffic among all services is handled by the edge server 14. Under a condition where one service at a time is allowed to be assigned to the edge server 14, this situation is the most advantageous to minimize the traffic amount between the terminals 28, 30 and the data network 22. Therefore, if α<βmax is not met, the MEC control server 20 maintains the current condition and simply terminates this process.

On the other hand, if it is determined in step 102 that α<βmax is true, then it can be judged that the service with the largest traffic amount is being processed by the server on the data network 22 side. In this case, the MEC control server 20 rearranges the contents within edge server 14 so that the service is supported by the edge server 14 (step 104).

Once the processing of the above step 104 is completed, thereafter, the edge server 14 executes switching so as to handle the service with traffic amount βmax and hand over the service that generates traffic amount α to the server on the data network 22 side.

According to the above process, by switching the contents of the edge server 14 based on the traffic amount from terminals 28 and 30, it is possible to reduce the traffic amount within the HAPS network 10 and between the HAPS network 10 and the terrestrial data network 22. In the situation described with reference to FIG. 6, the traffic amount on the feeder link is reduced from 200 Mbit/s to 100 Mbit/s by the above process. For example, when the communication capacity of the feeder link is small, it is possible to reduce the traffic congestion by reducing the traffic amount through control like in the present embodiment.

Furthermore, in the first embodiment described above, an example was explained where the edge server 14 handles only one service with the maximum traffic amount, but the present disclosure is not limited to that. If the edge server 14 has additional processing capacity, it may handle a plurality of services.

### Second Embodiment

The system configuration assumed in the present embodiment is similar to that shown in FIG. 5. In the aforementioned first embodiment, the traffic amount (α and βmax) occurring in each of the data sharing service and dynamic image processing service is observed, and the content is switched in such a manner that the service with a high traffic amount is processed by the edge server 14. However, the traffic amount of each service may fluctuate within a certain time frame. Therefore, in the method of the first embodiment, content switching control may occur multiple times within a certain period. As a result, there is a possibility that transient disconnections of service as well as traffic increase due to the handover of content data in the network will frequently occur.

In the present embodiment, in addition to comparing the traffic amount of both services, a comparison is made between a threshold T and a difference Y in traffic amounts (α and βmax) of both services. Further, when the difference γ between the two exceeds the threshold T, the content of the edge server 14 is to be replaced. In other words, the content will be swapped when the traffic amount βmax processed by the server on the data network side 22 exceeds the sum of α and the threshold T.

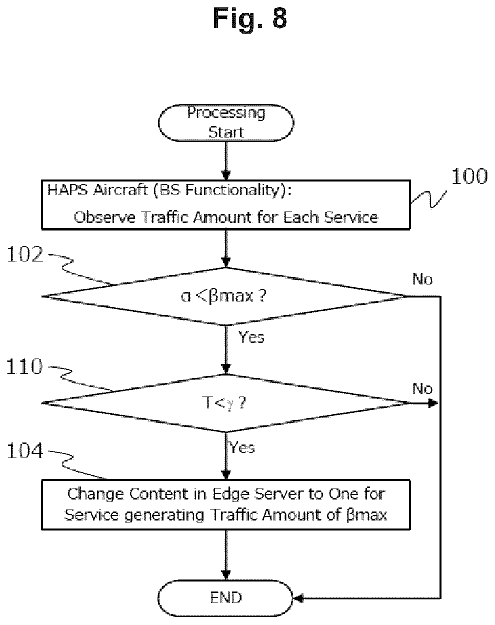

The flowchart for this situation is as shown in FIG. 8. Moreover, in FIG. 8, the steps that execute the same processes as those shown in FIG. 7 are denoted by common reference numbers, and their descriptions are omitted or simplified.

That is, according to the flowchart shown in FIG. 8, when α<βmax is established in step 102, it is next determined whether T<γ is satisfied (step 110). “T” is the switch threshold used to decide whether the content needs to be replaced. On the other hand, ‘γ’ refers to the absolute value |βmax−α| of the difference between the edge-handled traffic amount α and the maximum value βmax of the network-handled traffic amount β.

In the present embodiment, if T<γdoes not hold true in step 110, step 104 is skipped, and no content switching occurs. Then, when it is recognized that T<γ holds, it is determined that βmax is sufficiently larger than α, leading to the processing of step 104, i.e., the replacement of content on the edge server 14.

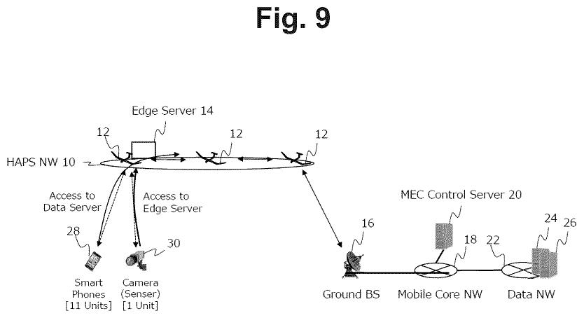

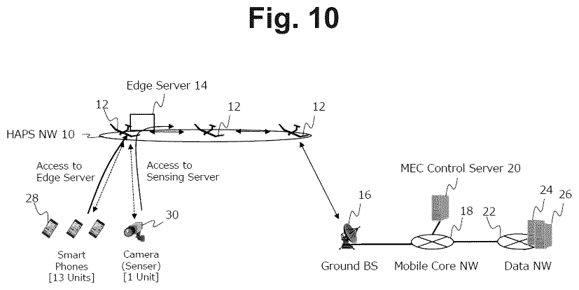

Here, the operation when the situation described with reference to FIG. 5 changes to the situation shown in FIG. 9, and further to the situation shown in FIG. 10, will be explained below. In this example, it should be noted that the above-mentioned threshold T is assumed to be set at 20 Mbit/s.

In the situation depicted in FIG. 5, the traffic amount for one smartphone is 10 Mbit/s and for five devices receiving data sharing services is 50 Mbit/s, as mentioned above. On the other hand, the traffic amount for one camera receiving video processing services is 100 Mbit/s. In this case, the edge-compatible traffic amount α is 100 Mbit/s, and the maximum value for network-handled traffic amount ßmax is 50 Mbit/s.

Next, as shown in FIG. 9, assuming the number of smartphones 28 receiving data sharing services increases to eleven, and they all connect to the edge server 14 on the HAPS aircraft 12. The traffic amount from the eleven smartphones 28 becomes 110 Mbit/s. In this case, while βmax becomes 110 Mbit/s, the difference γ between α and βmax becomes 10 Mbit/s, which is smaller than the threshold T of 20 Mbit/s. The traffic amount from eleven smartphones 28 exceeds that from the camera 30; however, because the difference γ is not greater than the threshold T, content switching control is not performed at this stage.

Next, as shown in FIG. 10, assuming that the number of smartphones 28 receiving the data sharing service increases to thirteen, and they connect to the edge server 14 of the HAPS aircraft 12. The traffic amount from thirteen smartphones 28 reaches 130 Mbit/s. In this case, βmax becomes 130 Mbit/s, and the difference γ between α and βmax becomes 30 Mbit/s, which is larger than the threshold T of 20 Mbit/s. At this stage, because the difference γ exceeds the threshold T, the control to switch contents is executed.

As described above, in the present embodiment, the necessity of content switching is determined by also considering the difference in traffic amount of the service handled by the edge server 14 and the service handled by the server on the data network 22 side in addition to comparing the amount of traffic between services. For this reason, it is possible to suppress frequent content switching and reduce the traffic load within the HAPS network as well as between the HAPS network and the terrestrial data network 22.

In the second embodiment described above, the Yes or No of T<γ is determined in step 110 after determining the Yes or No of α<βmax in step 102. However, the present disclosure is not limited to this, and the above determination may also be consolidated into a judgment of α<(βmax−T).

Moreover, in the second embodiment described above, while the difference γ between two traffic amounts (α and βmax) is used to impart a hysteresis characteristic to the determination of whether content switching is necessary, the present disclosure is not limited to that. For instance, it may provide a hysteresis characteristic to the aforementioned necessity determination by comparing the ratio of two traffic amounts (βmax/α) with a threshold.

### Third Embodiment

The system configuration assumed in the present embodiment is the same as shown in FIG. 6. However, the ground base station 16 has a functionality of monitoring the communication state of the feeder link and notifying the MEC control server when an event of frequent transient disconnection occurs on the feeder link. The wireless link (feeder link) between the HAPS aircraft 12 and the ground base station 16 uses a high frequency band to achieve a wide bandwidth. Therefore, the attenuation of radio waves due to rainfall increases, which raises the possibility of transient disconnections occurring.

As explained with reference to FIG. 6, twenty smartphones 28 are currently connecting to the edge server 14 mounted on the HAPS aircraft 12 to receive data sharing services. In the data sharing service, file sharing is carried out in response to demands from the smartphones 28. In this type of service, an increase in response time due to the transient disconnections of network is somewhat permissible.

On the other hand, the camera 30 is connected to the sensing server 26 on the data network 22, and the image signal processing is performed by the sensing server 26. The analysis of camera images needs to be performed constantly, and the image information from the camera 30 is sent sequentially to the sensing server 26 so as to be processed in real time. Therefore, if the transmission of image information is interrupted due to transient disconnections in the network, it will deteriorate the real-time analysis of camera images.

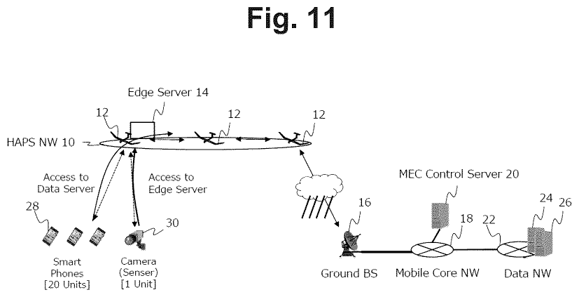

Here, assuming that rainfall occurs near the ground base station 16 as shown in FIG. 11. Under such a situation, the feeder link may become unstable, and transient disconnections may occur due to radio wave attenuation. When the ground base station 16 detects a transient disconnection of the feeder link, it notifies the MEC control server 20 of the situation. Upon receiving the rain notification, the MEC control server 20 transfers data files stored on the edge server 14 of the HAPS aircraft 12 to the data server 24 and activates the video signal processing functionality if it is determined that a transient disconnection occurs frequently. Then, the content on the edge server 14 is switched from one for the data sharing service to another for the signal processing of video and images.

Hereafter, images sent from camera 30 are transmitted to the edge server 14 and are signal processed at the edge server 14. Additionally, smartphone 28 accesses the data server 24 on data network 22 to receive the data sharing service.

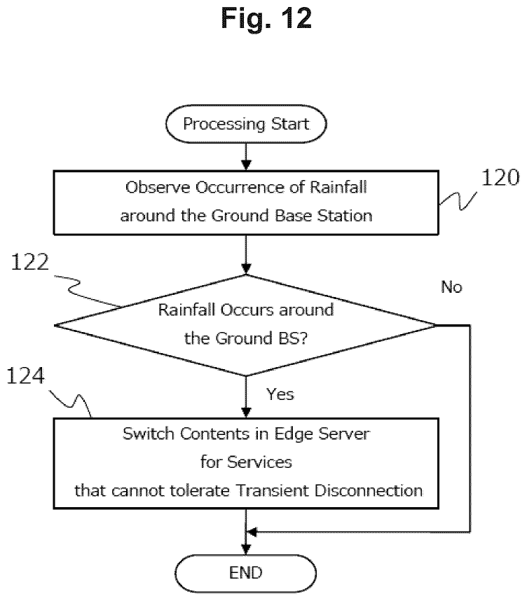

The flowchart at this stage is as shown in FIG. 12. The series of processes shown in FIG. 12 are primarily executed at the ground base station 16 and the MEC control server 20.

As shown in FIG. 12, in the present embodiment, the ground base station 16 observes an occurrence of rainfall in its vicinity (Step 120). More specifically, the ground base station 16 acquires weather information from external sources and detects the occurrence of rainfall within a defined area surrounding it.

Next, the ground base station 16 determines whether rainfall occurs in its vicinity (Step 122). More specifically, it determines whether rainfall exceeding a threshold level is occurring within a specified area surrounding itself. As a result, if no rainfall is detected, it can be concluded that there is a low possibility of transient disconnections occurring on the feeder link. In this case, the current routine is terminated without any further special processing.

On the other hand, in step 122 mentioned above, if rainfall is observed in the vicinity, the ground base station 16 judges that there is a high possibility of a transient disconnection occurring in the feeder link. In this case, a content replacement process is conducted to transfer the service that cannot tolerate transient disconnections from the network side to the edge server 14 (step 124).

In this Step 124, specifically, first, the possibility of a feeder link transient disconnection is notified from the ground base station 16 to the MEC control server 20 (Step 124-1). Upon receiving this notification, the MEC control server 20 determines whether the service handled by the edge server 14 can tolerate a certain level of transient disconnection, such as a data sharing service (Step 124-2).

As a result, if it is determined that the service handled by the edge server 14 can tolerate transient disconnections, the MEC control server 20 further determines whether any service that cannot tolerate transient disconnections is handled by servers on the data network 22 side (Step 124-3).

Furthermore, if it is determined that any service which cannot tolerate transient disconnections is handled on the data network 22 side, the MEC control server 20 performs content replacement processing to switch the Service with the one which has been handled by the edge server 14 (Step 124-4).

In the content replacement process, the replacement command for services is issued from the MEC control server 20 to the servers (for example, 24, 26) on the data network 22 side, and to the edge server 14 on the HAPS vehicle 12. Upon receiving this command, the edge server 14 and the servers on the data network 22 side mutually exchange data necessary for providing the services they have been handling, and activate functionalities related to signal processing for newly handling services.

With the processing above, in the present embodiment, it is possible to switch the content of the edge server 14 based on the rain conditions near the ground base station 16. If the processing required to provide the service is performed by the edge server 14, transient disconnections of the feeder link will not adversely affect the quality of that service. Therefore, according to the system of the present embodiment, the services which cannot tolerate transient disconnections, such as moving image processing services, can be reliably provided even under adverse weather conditions.

In the aforementioned third embodiment, the control to replace the content of the edge server 14 was performed when rain was detected, but the present disclosure is not limited to this arrangement. For example, it may be possible to change the content of the edge server 14 in advance, using information such as weather forecasts, before rainfall occurs.

Furthermore, in the third embodiment described above, the content is changed when a transient disconnection in the feeder link is predicted from the rainfall situation; however, the present disclosure is not limited to this. For instance, by directly detecting the frequency of transient disconnections in the feeder link, the control for changing the content can be performed based on the detected results.

In the third embodiment described above, there is explained an example in which solely the process of replacing content according to a situation of rainfall is carried out on the system. However, the present disclosure is not limited to this. The content replacement process described in the third embodiment may be implemented in combination with the content replacement processes described in the first or the second embodiment.

Furthermore, in the aforementioned third embodiment, an example was provided where a service allowing for some delay and a service not allowing any delay are each provided, but the application of the present disclosure is not limited to this. For example, when two or more types of services that cannot tolerate delays are provided simultaneously, it may be possible to perform content replacement processing so that the service that is the least tolerant to delays or the service with the highest priority in terms of quality is processed by the edge server 14.

### Fourth Embodiment

As explained in the third embodiment above, feeder links become unstable and the possibility of transient disconnections increases during rainfall. As a countermeasure, it is conceivable to apply adaptive modulation control that changes the modulation method according to the amount of radio wave attenuation on the feeder link. For example, by observing the received power on the ground base station side 16, if the received power is high, a multilevel modulation method such as 16QAM is used. If the received power deteriorates, the modulation method is switched to a more robust one such as BPSK to avoid transient disconnections. However, using BPSK reduces the number of transmission bits per symbol, so during rainfall, the transmission capacity of the feeder link decreases, making it more susceptible to congestion in the NTN.

In the first or the second embodiment described above, if the traffic amount βmax handled by the servers on the data network 22 side is larger than the traffic amount α handled by the edge server 14, the control is performed to switch the services of the two. This control is effective in reducing the traffic amount directed to the data network 22, namely the traffic amount passing through the feeder link.

Thus, in the present embodiment, the application of adaptive modulation control to feeder links is implemented in combination with the content replacement control described in the first or the second embodiment. More specifically, the adaptive modulation control is applied to the feeder links in order to strengthen resistance to radio wave attenuation. Then, if the transmission capacity of the feeder link decreases as a result of the adaptive modulation control, the switch control of the content described in the first or the second embodiment is performed to avoid congestion in the

### Feeder Link Traffic.

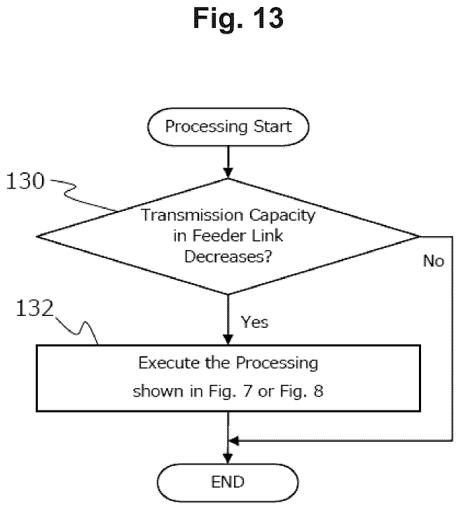

A flowchart illustrating the flow of processing in the present embodiment is shown in FIG. 13. The series of processes shown in FIG. 13 is executed in a distributed manner by the ground base station 16, the MEC control server 20, the edge server 14, and the servers on the data network 22 side. Moreover, the system of the present embodiment performs processes for applying adaptive modulation control to the feeder link separately from the series of processes shown in FIG. 13.

In the flowchart shown in FIG. 13, firstly, it is determined at ground base station 16 whether the transmission capacity of the feeder link has decreased (Step 130). The ground base station 16 measures the transmission capacity and can judge the decrease in the transmission capacity based on the measurement results. Specifically, this determination is made by checking if the transmission capacity of the feeder link has fallen below a certain threshold. Alternatively, the ground base station 16 may determine the fulfillment of the conditions of the present step 130 when a modulation method with low transmission capacity is selected through the adaptive modulation control.

In step 130, if no decrease is observed in the transmission capacity, it can be judged that there is no need to make any changes to the current situation. In this case, the present routine is promptly concluded.

On the other hand, if any degradation is observed in the transmission capacity in the above step 130, the process shown in FIG. 7 or the process shown in FIG. 8 is executed (step 132). Specifically, firstly, the necessity of content exchange control is notified to the HAPS aircraft 12 and the MEC control server 20. Subsequently, at either the base station functionality of the HAPS aircraft 12 or the MEC control server 20, the series of processes shown in FIG. 7 or FIG. 8 is executed.

According to the above process, if the transmission capacity of the feeder link decreases due to a change in the modulation scheme, this change is recognized by the ground base station 16. Subsequently, if the ground base station 16 recognizes the decrease, services with large traffic amounts are preferentially handed over to the edge server 14 in response to the command from the MEC control server 20. As a result, the amount of traffic routed through the feeder link is restrained, allowing the avoidance of traffic congestion regardless of changes in the modulation scheme.

### Variations of the Forth Embodiment

Incidentally, in the aforementioned for the embodiment, the necessity of the content replacement control is determined based on the transmission capacity of the feeder link, but the present disclosure is not limited to such an arrangement. For example, it may also be possible to execute similar controls based on the capacity of links within the NTN formed among entities such as HAPS.

### Fifth Embodiment

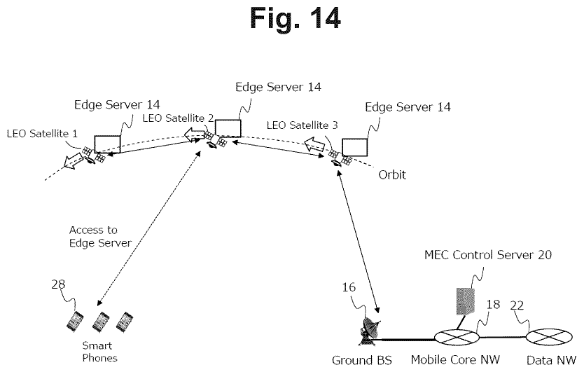

FIG. 14 shows the system configuration assumed in the present embodiment. In the present embodiment, an NTN comprising a network of LEO satellites is assumed. The connections between LEO satellites are made via wireless links. In addition, there are a mobile core network 18 and a data network 22 on the ground, and one of the LEO Satellites (LEO satellite 3 in FIG. 14) is connected to the ground base station 16 by a wireless link (feeder link).

The LEO satellites orbit at low altitudes. Unlike geostationary satellites, they do not appear stationary from the ground, and when observed from a fixed point on the ground, a single LEO satellite disappears from view in about 10 minutes. Therefore, a continuous communication service can be provided by placing a plurality of satellites in the same orbit to form a constellation and causing the plurality of satellites to interchangeably cover the same location. In the present embodiment as well, it is assumed that a plurality of LEO satellites are placed in orbit.

Each LEO satellite is equipped with a base station functionality and an edge server 14. As of the time depicted in FIG. 14, the smartphones 28 on the ground are connected to LEO satellite 2 and is further connected to the edge server 14 installed on LEO satellite 2 to receive data sharing services. Files are stored in the edge server 14, allowing them to be viewed from the smartphones 28. The user of the smartphones 28 can receive the services with low latency because the communication path can be completed by connecting to the edge server 14 without access to the ground data network 22.

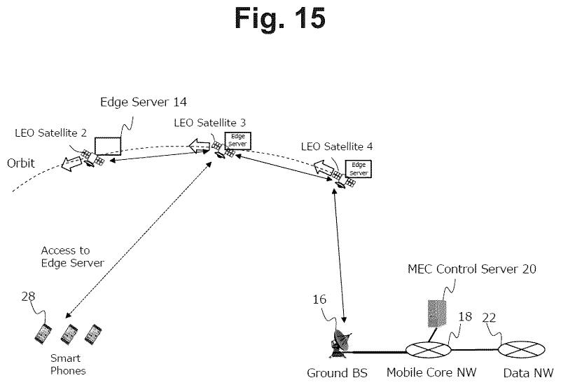

Next, assuming that time has passed and the LEO satellite has moved so as to arise the situation shown in FIG. 15. As the LEO satellite 1 descends below the horizon and the LEO satellite 2 is no longer visible from the ground, the smartphone 28 switches its connection to LEO satellite 3. The feeder link is also connected between LEO satellite 4 and the ground base station 16. At this time, the MEC control server 20 transfers the content that had been stored in each LEO satellite. Namely, it controls the transfer of data sharing service files stored in the edge server 14 of LEO satellite 2 to the edge server 14 within LEO satellite 3. The smartphones 28 on the ground connect to the edge server 14 of LEO satellite 3 and continue receiving data sharing services.

As above, the present embodiment allows for the provision of services while maintaining low latency by controlling the contents stored on the edge servers 14 based on the orbit information of LEO satellites. It should be noted that the smartphones 28 will need to access the edge server 14 of LEO satellite 2 via the wireless link between the satellites if the aforementioned content transfer is not performed. In this scenario, propagation delay occurs due to passing through the wireless link, causing latency to worsen compared to the present embodiment.

### Variations of the First to the Fifth Embodiments

Incidentally, each of the above first to five embodiments involve replacing contents in response to changes in real-time situations, but the present disclosure is not limited to such implementations. It is also possible to control the content on the edge server 14 by predicting the traffic amount due to time variations or events occurrence, based on information regarding the traffic amount of each service that has occurred in the past.

In addition, the first to the fifth embodiments described above all use non-terrestrial networks, but the present disclosure is not limited to that. The technology of the present disclosure can also be applied to a wireless communication system using a terrestrial network.

### EXPLANATION OF SYMBOLS

10 HAPS Network
12 HAPS aircraft
14 Edge Server
16 Ground Base Station
18 Mobile Core Network
20 MEC Control Server
22 Data Network
24 Data Server
26 Sensing Server
28 Smartphone (Terminal)
30 Camera (Terminal)

1. A wireless communication system utilizing a network, comprising:
one or more terminals which connect to a base station circuitry provided within said network;
an edge server provided within the network along with said base station circuitry; and
a non-edge server provided at a position away from said base station circuitry within the network, wherein
said wireless communication system is configured to perform content replacement for swapping the service handled by the edge server and the service handled by the non-edge server based on at least one of the required QoS of the services received by the terminal and the traffic volume generated by the group of terminals receiving the same service.

2. The wireless communication system according to claim 1, wherein
said network includes a non-terrestrial network composed of satellites or unmanned aerial vehicles,
said base station circuitry and said edge server are installed on either the satellite or the unmanned aerial vehicle,
said one or more terminals connect to the edge server via the satellite or the unmanned aerial vehicle, and
said content replacement is executed based on at least one of the followings: the required QoS of the service received by the terminal, the traffic volume generated by the group of terminals receiving the same service, the link capacity between the satellites or between the unmanned flying objects, the link capacity of the feeder link, the communication state of the feeder link, and the orbit/route of the satellite or the unmanned flying object.

3. The wireless communication system according to claim 1, wherein
necessity for said content replacement is determined so that a hysteresis characteristic is given to the determination by also using the comparison result between the difference or ratio of the traffic amount generated in the group of terminals receiving each service and a threshold value.

4. The wireless communication system according to claim 1, configured to further perform prediction of traffic volume due to change of time and/or occurrence of events based on the information of traffic volume of each service previously provided, wherein
necessity of said content replacement is determined based on the result of the prediction.

5. The wireless communication system according to claim 2, further comprising a ground base station which connects to the satellite or the unmanned aerial vehicle, and wherein
said wireless communication system is configured to further perform:
obtaining weather conditions around said ground base station; and
predicting the communication state of the feeder link formed between the satellite or the unmanned aerial vehicle and the ground base station based on said weather conditions, wherein
said content replacement is executed based on the prediction of the communication state.

6. A wireless communication circuitry incorporated into a wireless communication system, said wireless communication system comprising one or more terminals which connect to a base station circuitry provided within the network, an edge server provided within the network along with said base station circuitry, and a non-edge server provided at a position away from said base station circuitry within the network, wherein
said wireless communication circuitry is configured to perform content replacement for swapping the service handled by the edge server and the service handled by the non-edge server based on at least one of the required QoS of the services received by the terminal and the traffic volume generated by the group of terminals receiving the same service.

7. A wireless communication method utilizing a network, including:
causing one or more terminals to connect with a base station circuitry provided within the network;
causing an edge server installed within the network along with said base station circuitry to handle a first service required by a terminal;
causing a non-edge server installed within the network, being away from the base station circuitry, to handle a second service required by a terminal; and
swapping the service handled by said the edge server with the service handled by the non-edge server based on at least one of the required QoS of the services received by said terminal and the traffic volume generated by the group of terminals receiving the same service.

8. A computer readable storage medium storing a wireless communication program executed in a wireless communication circuitry incorporated into a wireless communication system, said wireless communication system comprising a one or more terminals which connect to a base station circuitry provided within the network, an edge server provided within the network along with said base station circuitry, and a non-edge server provided at a position away from said base station circuitry within the network, wherein
said wireless communication program includes a computer readable program for causing said wireless communication circuitry to perform the wireless communication method according to claim 7.
